(19) United States
(12) Patent Application Publication
(10) Pub. No.: US 2002/0006266 A1
(43) Pub. Date: Jan. 17, 2002

(54) Record/play apparatus and method for extracting and searching index simultaneously

(75) Inventors: Kyoung Ro Yoon, Seoul (KR); Sung Bae Jun, Seoul (KR); Chan Eui Cheong, Youngin-shi (KR); Ji Eun Lee, Seoul (KR)

Correspondence Address: Jonathan Y. Kang, Esq., Lee & Hong P.C., 11th Floor, 221 N. Figueroa Street, Los Angeles, CA, 90012-2001, US

(73) Assignee: LG Electronics Inc.

(21) Appl. No.: 09/905,548

(22) Filed: Jul. 13, 2001

(30) Foreign Application Priority Data
Jul. 14, 2000 (KR) P 2000-40592

(51) Int. Cl. H04N 5/91

(52) U.S. Cl. 386/69; 386/95; 348/112

(57) ABSTRACT

A client device (set-top box) allows to record and play simultaneously a multimedia stream transmitted from a broadcasting station or a video/radio server. The present invention enables to provide a user with a function of searching/filtering or browsing the previously-stored streams using structural/meaningful/summarized information to meet a user's demand by installing an automatic indexing/search device in a client device, such as a Tivo, Replay TV or the like which enables the user to record and play sound/video synchronously and store index information in a storage device by extracting and indexing meaningful/structural/summary information of a multimedia stream automatically when video/sound recording of the multimedia stream is carried out.

### CROSS REFERENCE TO RELATED ART

This application claims the benefit of Korean Patent Application No. 2000-40592, filed on Jul. 14, 2000, which is hereby incorporated by reference in its entirety.

### BACKGROUND OF THE INVENTION

1. Field of the Invention

The present invention relates to a record/play apparatus for extracting and searching index information simultaneously. More specifically, the present invention relates to carrying out a multimedia indexing function and a search/browsing finction simultaneously on a conventional client device (set-top box) which records and plays multimedia streams transmitted from a broadcasting station or an audio/video server.

2. Discussion of the Related Art

Lately, set-top boxes which enable to record and play sound/video synchronously, such as Tivo, Replay TV, etc., have been made possible with the advancement of technologies in multimedia stream storage, interface bus and the like. Moreover, additional technological developments in digital video and image/video/audio recognition has brought about multimedia indexing technology enabling a user to search/filter and browse specific parts of the multimedia content wanted by a user at a specific time.

Specifically, a user can be provided with content at the user-demanded time or access to the user-demanded parts of the content. In this case, the most popular method of browsing a user-demanded part is “non-linear browsing.” Basic techniques for non-linear multimedia content browsing and search are shot segmentation and shot clustering. These two techniques are the core prior art techniques in analyzing content structurally with meaning.

A shot in video means a sequence of frames captured by a camera without interruption, which becomes the basic unit for video analysis and construction. The concept of a shot may be applied to an audio program as well as a video in the same manner. A plurality of shots are generally included in one scene. A scene is generally defined as the basic component of a video, where the scene is a meaningful sectional element in a story development or a video constitution.

Lately, video indexing includes a method of providing highlights automatically and a method of providing key frames for providing a user with summarized information of multimedia content by extracting summary information of the multimedia content. Such index information basically describes which place in a multimedia program or stream, information is located at and contains temporal information based on the information designating the location.

As mentioned in the foregoing explanation, the client device, which enables to record and play sound/video synchronously, such as a Tivo or a Replay TV, can store and play synchronously the streams which are being broadcasted. Thereby, a user is enabled to browse the previously stored streams during watching/listening to a program. Namely, the client device, such as a Tivo or a Replay TV receives an analog stream, converts the inputted analog stream into a digital stream, and simultaneously stores and plays the digital stream. Therefore, a user enables to review the missed part during watching using an instant replay function as well as skip some parts unnecessary for browsing the previously-stored streams.

In this case, the instant replay function or skip function established in the previous Tivo or Replay TV enables to shift a part from the present location to another location displaced with a predetermined offset by considering a pre-set offset and the present location.

Unfortunately, the client device does not extract index information of the multimedia stream, thereby failing to provide convenient means for searching and browsing a user-demanded part in the previously-stored streams. Namely, the client device is unable to provide a convenient navigation method using the meaning information, structural information or summarized information existing in the video stream such as the core elements in the non-linear video browsing.

Besides, a user may try a non-linear access to watch/listen to a user-demanded part in the previously-recorded streams or during watching/listening the multimedia stream. Yet, the conventional client device copes with such a user's demand with temporal information reflecting on the present location, thereby failing to cope properly with the user's demand for the nonlinear access by taking a shot/scene, an event or appearance/disappearance of an object as a reference.

### SUMMARY OF THE INVENTION

Accordingly, the present invention is directed to a record/play apparatus and method for extracting and searching index information simultaneously that substantially obviates one or more problems due to limitations and disadvantages of the related art.

An object of the present invention is to provide a record/play apparatus and method for extracting and searching index information simultaneously which enables to carry out a multimedia indexing function and a search/browsing function simultaneously on a conventional client device which simultaneously records and plays multimedia streams transmitted from a broadcasting station or a video/audio server, thereby enabling to easily search/filter and browse specific parts of the multimedia content demanded by a user.

Another object of the present invention is to provide a record/play apparatus for extracting and searching index information simultaneously which enables to provide a user with a function of searching/filtering or browsing the previously-stored streams using structural/meaning/summarized information to meet a user's demand by installing an automatic indexing/search device in a client device which enables to record and play sound/video synchronously and storing index information in a storage device by extracting and indexing meaningful/structural/summary information of a multimedia stream automatically when video/sound recording of the multimedia stream is carried out.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a record/play apparatus for extracting and searching index information simultaneously includes a tuner selecting a demanded channel in broadcasting signals which are being received, a record control part controlling storage/play of a media stream of the selected channel, an indexing engine extracting index information from the media stream, a storage device storing the media stream inputted from the play control part and the index information extracted from the indexing engine therein, a search/browsing engine 500 carrying out search/browsing in accordance with a user's non-linear multimedia access demand using the stored index information, and a main control part controlling an entire flow of data and a control signal by receiving a command/control of the user and producing a required control signal.

Preferably, the record control part includes an encoder, when the media stream inputted from the tuner is an analog stream or an uncompressed data stream, converting the analog stream or the uncompressed data stream into a compressed digital stream in accordance with a control of the main control part and outputting the compressed digital stream to the indexing engine, and a storage control part controlling that the compressed digital stream is stored in the storage device.

And, the main control part includes an input interface receiving a command/input of the user, a control part, when index information is inputted from outside, processing the index information and producing a control signal to required part in accordance with the index information and the user's input, a display control/interface receiving an uncompressed stream and transferring the uncompressed stream to a display device, the display control/interface producing a necessary control signal if necessary, and a decoder converting the compressed stream stored in the storage device into an uncompressed stream and outputting the uncompressed stream to the display control/interface.

The main control part, when a partially-compressed stream is required for the indexing engine, controls the record control part in a manner that the indexing engine is provided with the partially-compressed stream which is an intermediate result value produced during compression.

And, the main control part provides the indexing engine with an uncompressed stream by controlling the record control part.

More preferably, the record control part, if the media stream inputted from the tuner is a compressed digital stream, outputs the media stream to the indexing engine as it is and enables to be constructed only with the storage control part controlling a storage of the compressed digital stream.

Further preferably, the index information extracted from the indexing engine is meaningful/structural/temporal information of multimedia content.

And, the meaningful information of the multimedia content extracted from the indexing engine is described in a manner that appearance and disappearance of an object, occurrence and end of an event, variance of a setting, state change of the object and the like are connected to the temporal information.

The structural information of the multimedia content extracted from the indexing engine includes structural information of the multimedia stream such as scenes, shots and the like.

The search/browsing engine provides information required for that the user enables to select a part to be transferred in the multimedia content stored in the storage device based on the index information.

The search/browsing engine provides summary information of the multimedia content selected by the user based on the index information stored in the storage device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 illustrates a block diagram of a record/play apparatus for extracting and searching index information simultaneously according to an embodiment of the present invention;

FIGS. 2 to FIGS. 5 illustrate constructional block diagrams for data stream flows in a record control part of the present invention;

FIG. 6 illustrates a block diagram of a main control part of the present invention; and

FIG. 7 illustrates a schematic drawing of a detailed construction of a main control part according to the present invention.

### DETAILED DESCRIPTION OF THE PREFERRED EMBODIMENTS

The present invention provides new functionality to existing client devices. By including an indexing engine to automatically produce meaningful/structural/summary information as index information of a multimedia stream in a client device, the present invention allows the user to record/play the multimedia stream simultaneously, store the index information in a set format and allows a search engine/browser to respond to the non-linear multimedia stream access demand of a user using the stored index information. Thus, the present invention enables to provide a convenient browsing function to meet a user's non-linear access demand to a multimedia stream through a user input device such a keyboard, a remote control and the like using indexed data and stored stream data as well as control the play of a display device on the basis of such index data.

Reference will now be made in detail to the preferred embodiments of the present invention, examples of which are illustrated in the accompanying drawings.

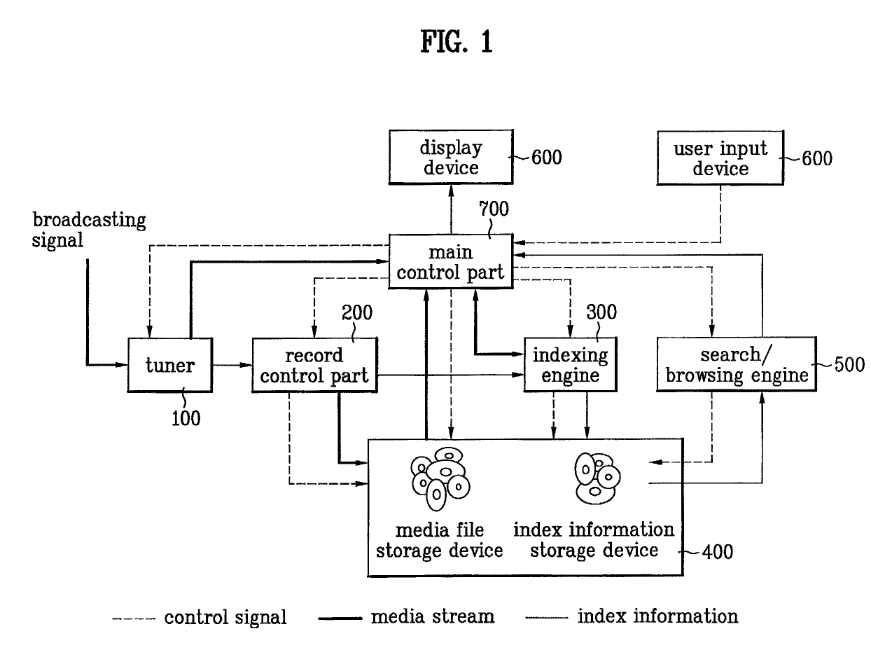

FIG. 1 illustrates a block diagram of a record/play apparatus for extracting and searching index information simultaneously according to an embodiment of the present invention. Referring to FIG. 1, a record/play apparatus for extracting and searching index information simultaneously according to an embodiment of the present invention includes a tuner 100 selecting a wanted channel (or a specific program) in a broadcasting stream received through an input part, a record control part 200 enabling to store/play a broadcasting media stream simultaneously, an indexing engine 300 extracting index information from the media stream, a storage device 400 storing the media stream inputted from the record cord control part 200 and the index information extracted from the indexing engine 300, a search/browsing engine 500 enabling to search/browse using the stored index information, a user input device 600 for inputting a command/control of a user, a main control part 700 controlling a flow of entire data and a control signal and producing a required control signal, and a display device 800.

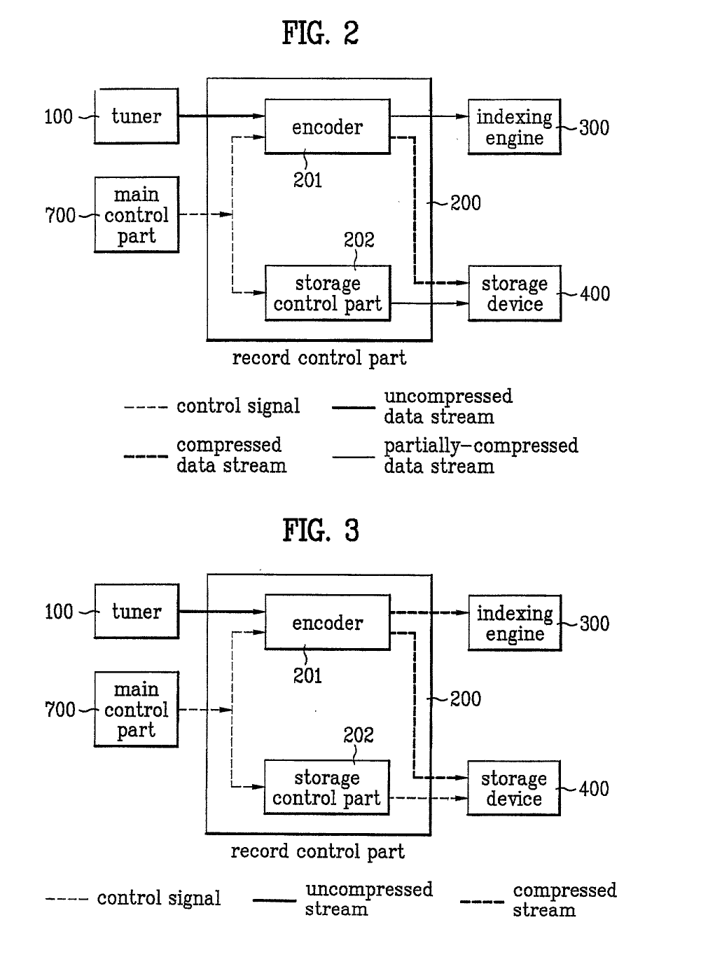

The record control part 200 includes an encoder 201 (shown in FIGS. 2-5) converting an analog data stream or an uncompressed data stream into a digital stream and a storage control part 202 (shown in FIGS. 2-5) controlling a storage of the compressed digital stream.

In the above-constructed embodiment of the present invention, a user selects a channel through the user input device 600, and the main control part 700 controls that the selected channel (or specific program) for the received broadcast signal is inputted by adjusting the tuner 100. A media stream of the inputted channel (or specific program) is inputted into the main control part 700 and record control part 200 so as to be used for play and record.

In this case, the received stream which is digital is stored on the storage device 400 without passing through an auxiliary encoder which is the encoder 201 of the record control part 200. Otherwise, the received stream, which is analog, is stored on the storage device 400 after being converted into a digital stream through the encoder 201.

The indexing engine 300 extracts meaningful/structural/summary information from the outputted digital stream from the record control part 200 and stores the extracted meaningful/structural/summary information in an index file structure of the storage device 400 in connection with temporal information of the stream which is being recorded.

In this case, the meaningful information of multimedia content extracted from the indexing engine 300 is described in connection between the temporal information and appearance/disappearance of an object, occurrence/end of an event, variance of a setting, state variance of an object and the like.

Moreover, the structural information of the multimedia content extracted from the indexing engine 300 contains structural information of the multimedia stream such as shots, scenes, etc.

In this case, when a search or browsing demand of a user using the index information is inputted through the user input device 600, the main control part 700 transfers the demand to the search/browsing engine 500. Subsequently, the browsing engine 500 extracts user-demand information using the index file structure stored in the storage device 400, and then transfers the extracted user-demand information to the main control part 700.

The main control part 700 uses the previously-stored multimedia stream data stored in the storage device 400 on the basis of the result from the search/browsing engine 500 so as to realize the shift to the demanded part or the browsing of the demanded part.

FIGS. 2-5 describe how the record control part 200 is able to realize a variety of constructions in accordance with the species of the inputted data (for instance, compressed digital stream, uncompressed digital stream, and uncompressed analog stream).

FIG. 2 illustrates a constructional block diagram for a data stream flow in a record control part 200 of the present invention. Referring to FIG. 2, when an analog stream or an uncompressed digital stream is received, the encoder 201 of the record control part 200 receives the analog stream or uncompressed digital stream from the tuner 100 and then converts the analog/uncompressed digital stream into a compressed digital stream by receiving a control signal from the main control part 700. Then, the compressed digital stream is stored in the storage device 400 by the control of the storage control part 202.

In this case, the encoder 201 sends the converted compressed digital stream to the indexing engine 300 so as to extract index information.

FIG. 2 represents that a stream, which is partially compressed by the encoder 201, is transferred to the indexing engine 300. In this case, the partially-compressed stream means that the indexing engine 300 is enabled to receive an intermediate result from the compression, if necessary.

FIG. 3 illustrates another constructional block diagram for a data stream flow in a record control part 200 according to the present invention. Referring to FIG. 3, when an analog data stream or an uncompressed data stream is received, the encoder 201 converts the analog data stream or uncompressed digital stream into a compressed digital stream in accordance with a control of the main control part 700. Then, the compressed digital stream is outputted to the indexing engine for indexing as soon as stored in the storage device 400 by the control of the storage control part 202.

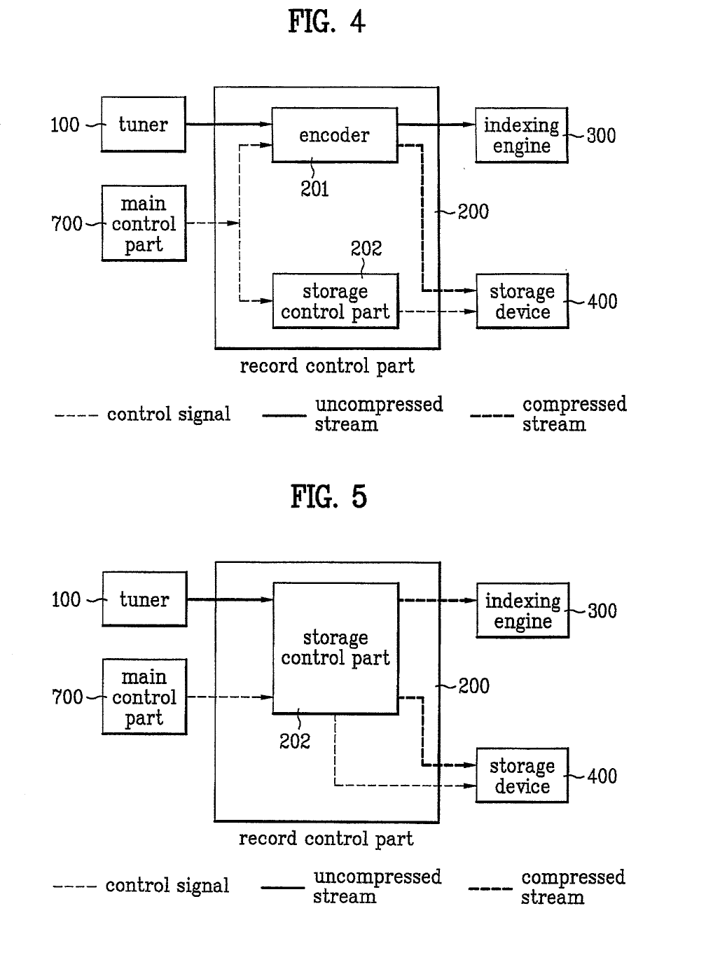

FIG. 4 illustrates a further constructional block diagram for a data stream flow in a record control part 200 according to the present invention. Referring to FIG. 4, when an analog data stream or an uncompressed data stream is received, the record control part 200 sends the uncompressed stream to the indexing engine 300 as it is. Namely, the encoder 201 outputs the analog data stream or uncompressed digital stream to the indexing engine 300 in accordance with a control of the main control part 700. Simultaneously, the encoder 201 converts the analog data stream or uncompressed digital stream into a compressed digital stream and then stores the compressed digital stream in the storage device 400 by the control of the storage control part 202.

FIG. 5 illustrates another further constructional block diagram for a data stream flow in a record control part 200 according to the present invention. Referring to FIG. 5, when a compressed data stream is received, the record control part 200 is constructed only with the storage control part 202 receiving the compressed digital stream from the tuner 100 and storing the compressed digital stream in the storage device 400 by receiving a control signal from the main control part 700. In this case, the indexing engine 300 receives the compressed digital stream directly from the tuner 100.

As shown in FIG. 2 to FIG. 5, the record control part 200 enables to realize a variety of constructions in accordance with the species of the inputted data (for instance, compressed digital stream, uncompressed digital stream, and uncompressed analog stream). The present invention is characterized in that an inputted data stream is converted into a compressed digital stream, the compressed digital stream is stored in the storage device 400 as soon as the data stream (one of an analog stream or a digital stream which is compressed/partially compressed/uncompressed) is transferred to the indexing engine for index information extraction.

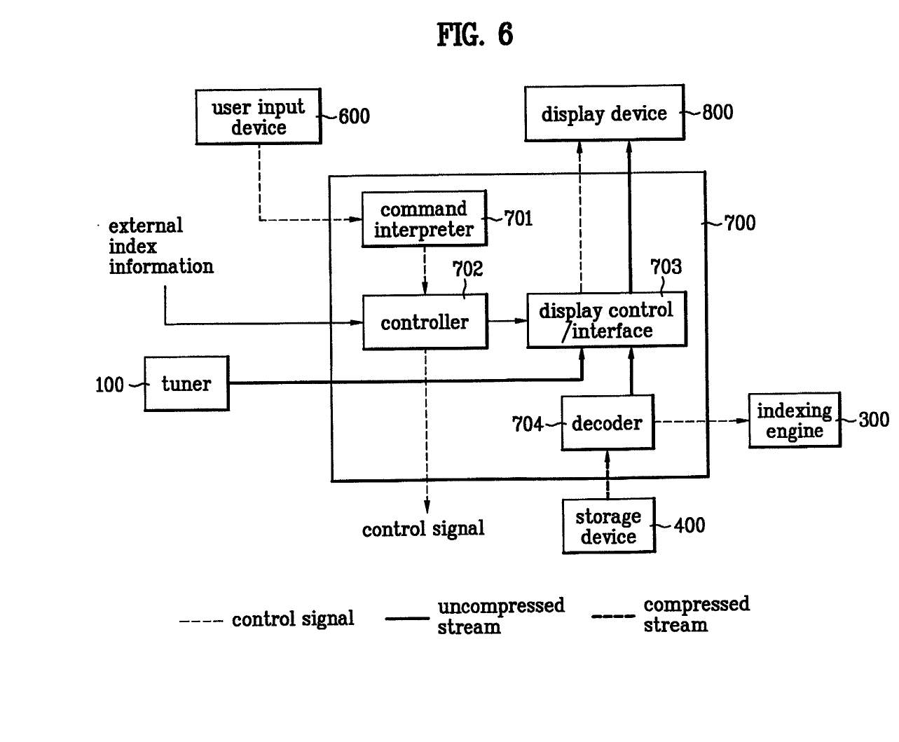

FIG. 6 illustrates a block diagram of a main control part 700 of the present invention. Referring to FIG. 6, the main control part 700 according to an embodiment the present invention includes an input interface (or command interpreter) 701 receiving a command/input of a user, a controller 702 processing index data received from external sources (for example, signals sending the data to the indexing engine 300) and producing a control signal for other parts by receiving the index data, user input and the like, a display control/interface 703 transferring an uncompressed stream to a display device/playback device 800 and producing a necessary control signal, and a decoder (decompression module) 704 converting the compressed stream stored in the storage device 400 into an uncompressed stream.

Alternatively, the main control part 700 may be altered into various constitutions. For instance, when index data are inputted from the tuner 100 with a media stream, a module for separating the index data from the media stream may be added to the main control part 700. When the display device 800 receives a compressed media stream as an input, the decoder may be removed away from the main control part 700. Moreover, a decoded (partially or completely) media stream, if necessary, may be fed back to the indexing engine 300. The present invention is characterized in that the storage device 400 receives index information as well as stores required segments therein. Then the stream received from the storage device 400 is transferred to the display device 800 after a required processing.

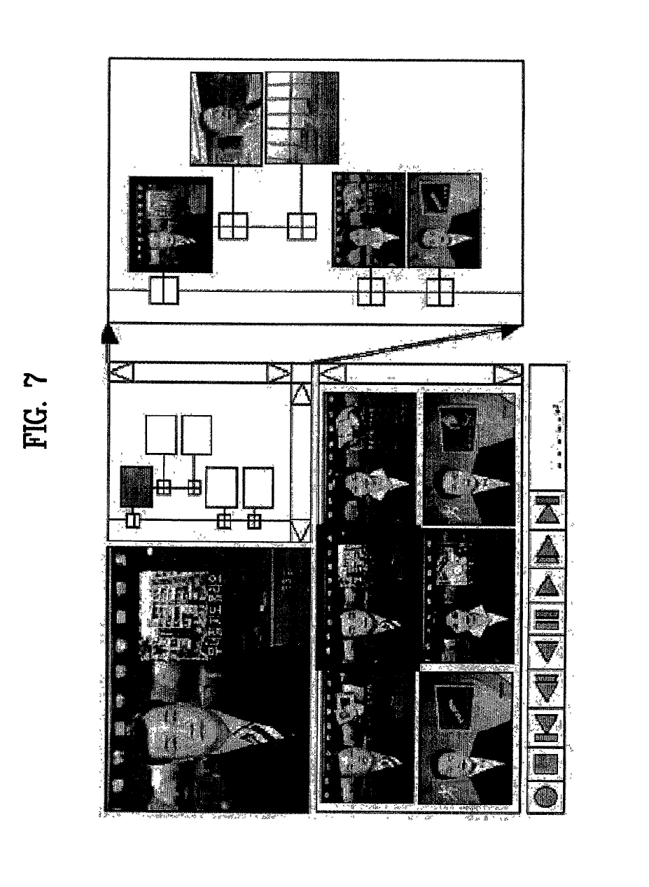

When a media stream contains no index information, the indexing engine 300 extracts structural/meaningful/temporal information, processes this information into an index information structure and stores this structure in the storage device 400. Based on the index information, the search/browsing engine 500 extracts to provide various browsing interfaces such as shown in FIG. 7. And, the search/browsing engine 500 extracts information of a specific media segment demanded by a user using the index information such as meaningful information/structural information/temporal information/summary information and the like and then enables to display the specific interesting segment.

Moreover, the search/browsing engine 500 may provide summary information. Namely, the indexing engine 300 extracts and stores the index information, while the search/browsing engine 500 retrieves index information fitting for the user's demand from the index information structure. In this case, the summary information may include key frame/key region information.

FIG. 7 shows an example of a browsing interface. The present invention enables to provide a user with a browsing interface as shown in the example through the display device 800 by being equipped with the indexing engine 300 and search/browsing engine 400. When such a browsing interface is provided, a user selects a demanded part (segment) using the user input device 600 so as to skip to the demanded part immediately. Thus, the present invention enables to be applied to the set-top using an analog or digital stream as an input.

The object of the present invention is to support a user's non-linear multimedia stream play occurring frequently on watching/listening to a multimedia stream. As a general user's nonlinear play control demand for the multimedia stream uses structural/meaningful information as well as a simple temporal unit, such a user's demand is satisfied with ease by using the present invention.

The construction and operation of the apparatus realized by the present invention enables to be applied to any media regardless of program genres. Moreover, the present invention has no connection with the facts that a program is received real-time through a public wave or a cable and that the off-line stored program is inputted through an interface, but enables to be applied the case that real stream data are inputted through the input interface of the present invention.

The present invention, when index information fails to be received, carries out both a stream data receive and index information extraction so as to stored them in the index information structure. When index information is received, the present invention transforms the index information into a structure fit for the index information structure. Besides, when the stored stream is played, a simple play using no index information is possible. But, when a user demands to play a non-linear stream, the stream play is controlled using the index information stored in the index information structure.

Accordingly, the present invention enables the ability to simultaneously store/play, produce an index information structure and control the play using the index information. Therefore, a user is provided with various convenient functions such as the play of a user demanded part on demand, the shift of the play part using index information and the like.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A record/play apparatus for extracting and searching index information simultaneously from broadcast signals, comprising:
a tuner for selecting a demanded channel from received broadcast signals;
a record control part for controlling storage/play of a media stream of the selected channel;
an indexing engine for extracting index information from the media stream;
a storage device for storing the media stream inputted from the play control part and the index information extracted from the indexing engine;
a search/browsing engine for carrying out search/browsing in accordance with a nonlinear multimedia access demand from a user using the stored index information; and
a main control part for controlling an entire flow of data and a control signal by receiving a command/control of the user and producing a required control signal.

2. The record/play apparatus of claim 1, wherein the record control part further comprises:
an encoder for converting an analog stream or an uncompressed data stream into a compressed digital stream and outputting the compressed digital stream to the indexing engine; and
a storage control part for storing the compressed digital stream in the storage device.

3. The record/play apparatus of claim 1, wherein the main control part further comprises:
a input interface for receiving an input of the user;
a controller for processing the index information and producing a control signal for required part in accordance with the index information and the input of the user when index information is inputted from an external source;
a decoder for converting the compressed stream stored in the storage device into an uncompressed stream and outputting the uncompressed stream; and
a display control/interface for receiving the uncompressed stream and transferring the uncompressed stream to a display device.

4. The record/play apparatus of claim 3, wherein the main control part further comprises a separation module for separating the index data from the media stream when the index information is inputted from the tuner with the media stream.

5. The record/play apparatus of claim 1, wherein the main control part, when a partially-compressed stream is required for the indexing engine, controls the record control part in a manner that the indexing engine is provided with the partially-compressed stream.

6. The record/play apparatus of claim 1, wherein the main control part provides the indexing engine with an uncompressed stream by controlling the record control part.

7. The record/play apparatus of claim 1, wherein the index information extracted from the indexing engine is meaningful/structural/temporal information of multimedia content.

8. The record/play apparatus of claim 7, wherein the indexing engine, based on the extracted index information, stores summary information, key frame information, key region information in connection with the entire temporal information.

9. The record/play apparatus of claim 7, wherein the meaningful information of the multimedia content extracted from the indexing engine is described in a manner that appearance and disappearance of an object, occurrence and end of an event, variance of a setting, state change of the object are connected to the temporal information.

10. The record/play apparatus of claim 7, wherein the structural information of the multimedia content extracted from the indexing engine includes structural information of the multimedia stream such as scenes and shots.

11. The record/play apparatus of claim 7, wherein the search/browsing engine provides information required for the user to be able to select a part to be transferred in the multimedia content stored in the storage device based on the index information.

12. The record/play apparatus of claim 1, wherein the search/browsing engine provides summary information of the multimedia content selected by the user based on the index information stored in the storage device.

13. A method for extracting and searching index information simultaneously from broadcast signals, comprising:
selecting a demanded channel from received broadcast signals;
controlling storage/play of a media stream of the selected channel;
extracting index information from the media stream;
storing the media stream inputted from a play control part and the index information extracted from an indexing engine;
carrying out search/browsing in accordance with a non-linear multimedia access demand from a user using the stored index information; and
controlling an entire flow of data and a control signal by receiving a command/control of the user and producing a required control signal.

14. The method of claim 13, wherein the step of controlling the storage/play of a media stream further comprises:
converting an analog stream or an uncompressed data stream into a compressed digital stream and outputting the compressed digital stream to the indexing engine; and
storing the compressed digital stream in the storage device.

15. The method of claim 13, wherein the step of controlling an entire flow of data and a control signal further comprises:
receiving an input of the user;
processing the index information and producing a control signal for required part in accordance with the index information and the input of the user when index information is inputted from an external source;
converting the compressed stream stored in the storage device into an uncompressed stream and outputting the uncompressed stream to a display control/interface; and
transferring the uncompressed stream to a display device.

16. The method of claim 15, wherein the step of controlling an entire flow of data and a control signal further comprises separating the index data from the media stream when the index information is inputted from the tuner with the media stream.

17. The method of claim 13, further comprising: when a partially-compressed stream is required for the indexing engine, controlling the record control part in a manner that the indexing engine is provided with the partially-compressed stream.

18. The method of claim 13, wherein the step of controlling an entire flow of data and a control signal further comprises providing the indexing engine with an uncompressed stream by controlling a record control part.

19. The method of claim 13, wherein the index information extracted from the indexing engine is meaningful/structural/temporal information of multimedia content.

20. The method of claim 19, wherein the indexing engine, based on the extracted index information, stores summary information, key frame information, key region information in connection with the entire temporal information.

21. The method of claim 19, wherein the meaningful information of the multimedia content extracted from the indexing engine is described in a manner that appearance and disappearance of an object, occurrence and end of an event, variance of a setting, state change of the object are connected to the temporal information.

22. The method of claim 19, wherein the structural information of the multimedia content extracted from the indexing engine includes structural information of the multimedia stream such as scenes and shots.

23. The method of claim 19, wherein the step of carrying out search/browsing in accordance with a non-linear multimedia access demand from a user further comprises providing information required for the user to be able to select a part to be transferred in the multimedia content stored in the storage device based on the index information.

24. The method of claim 13, wherein the step of carrying out search/browsing in accordance with a non-linear multimedia access demand from a user further comprises providing summary information of the multimedia content selected by the user based on the index information stored in the storage device.
